(19) United States
(12) Patent Application Publication
(10) Pub. No.: US 2008/0101273 A1
(43) Pub. Date: May 1, 2008

(54) WIRELESS DEVICE ASSOCIATION

(75) Inventor: Paul S. Everest, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/553,525

(22) Filed: Oct. 27, 2006

(51) Int. Cl. H04J 3/08

(52) U.S. Cl. 370/315

(57) ABSTRACT

A method and apparatus to associate a first wireless device and a second wireless device by storing a random identifier on a first wireless device and on a physical key and by moving the random identifier on the physical key to a second wireless device.

### BACKGROUND

The association of two or more wireless devices that lack built-in associations with one another is sometimes achieved using a display with a keypad or a keyboard and/or cables. Such methods for associating wireless devices add complexity and cost.

### BRIEF DESCRIPTION OF THE DRAWINGS

FIG. 1 is a functional block diagram schematically illustrating a wireless device association system according to an example embodiment.

FIG. 2 is a functional block diagram schematically illustrating a wireless device and key of the system of FIG. 1 according to an example embodiment.

FIG. 3 is a flow diagram illustrating a method for associating wireless devices according to an example embodiment.

FIG. 4 is a flow diagram illustrating another method for associating wireless devices according to an example embodiment.

FIG. 5 is a flow diagram illustrating another method for associating wireless devices according to an example embodiment.

FIG. 6 is a functional block diagram schematically illustrating another embodiment of the wireless device and the key of the system of FIG. 1 according to an example embodiment.

FIG. 7 is a functional block diagram schematically illustrating another embodiment of the wireless device association system of FIG. 1 according to an example embodiment.

### DETAILED DESCRIPTION OF THE EXAMPLE EMBODIMENTS

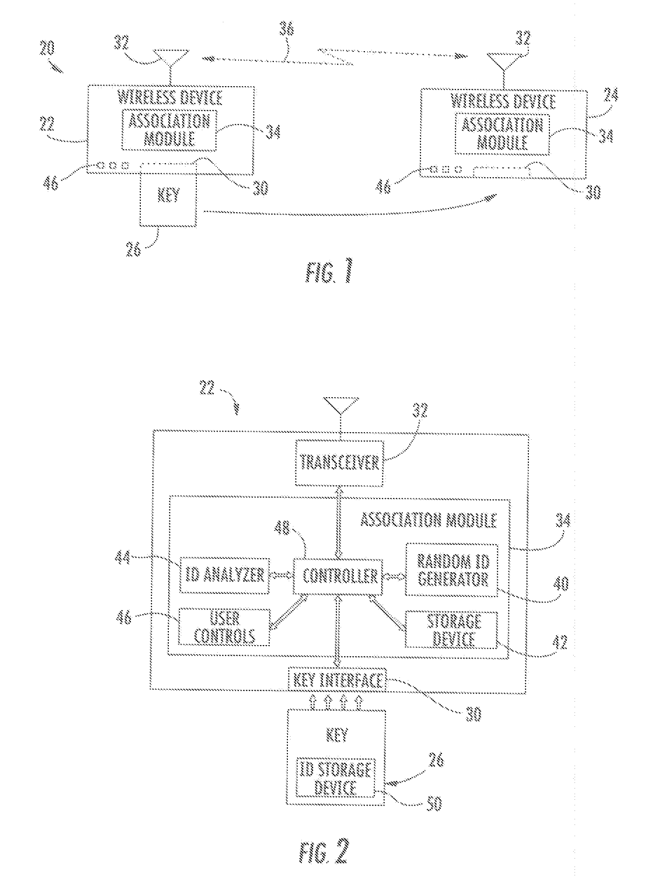

FIG. 1 is a functional block diagram illustrating one embodiment of a wireless device association system 20. System 20 is configured to associate two wireless devices having no built in association to one another using a physical token or key. For purposes of this disclosure, the term “association” shall mean a process that is performed by a user to establish a secure communication link between two wireless devices and to prevent a communication link from being established between the “associated” wireless devices and other unassociated wireless devices. In particular embodiments, such association is achieved without reliance upon a complex user interface, such as a keypad, keyboard or display and without reliance upon a temporary physical connection between the two devices such as a cable. System 20 associates the two wireless devices with reduced complexity and cost.

System 20 includes a wireless device 22, wireless device 24 and key 26. Wireless device 22 is a wireless device that has no built-in association with a wireless device 24. Likewise, wireless device 24 has no built-in association with wireless device 22. For example, wireless devices 22 and 24 may be devices that are purchased separately and that are subsequently associated with one another to establish a communication link therebetween.

In one embodiment, wireless device 22 is one of a wireless video source and a wireless video presentation device while wireless device 24 is the other of the wireless video source and the wireless video presentation device. Examples of a wireless video source include, but are not limited to, a videocassette player, a video disc player, a set-top cable box, a set-top satellite box, and an integrated circuit video player. Such video sources may be incorporated as part of a wireless device having additional functionality other than playing or reading video from a storage medium. For example, such video sources may additionally be configured to record video, to play audio or to both record and play audio. Examples of a wireless video presentation device include, but are not limited to, a wireless video display or a wireless video projector. Such video presentation devices may be incorporated as part of a wireless device having additional functionality other than presenting or displaying video. For example, such video presentation devices may additionally be configured to play audio. In still other embodiments, wireless devices 22 and 24 may comprise other presently developed or future developed forms of wireless devices that wirelessly communicate with one another and that omit built-in association.

In the example illustrated, each of wireless devices 22 and 24 includes a key interface 30, a wireless transceiver 32 and an association module 34. Key interface 30 is a structure or device configured to facilitate communication between key 26 and the corresponding wireless device 22, 24. In one embodiment, key interface 30 is a physical structure, such as a port, dock, plug or plug opening configured to facilitate physical connection between key 26 and the corresponding wireless device 22, 24. For example, key interface 30 may comprise a slot or opening in a housing of wireless device 22 or 24 into which key 26 may be partially or completely inserted and stationarily retained to establish a signal transmitting or moving connection therebetween, to permit data to be read from key 26 and to permit data to be written to key 26. In some embodiments, data may be transferred to the wireless device 22, 24 by key 26. In yet another embodiment, key interface 30 may comprise a slot or channel into which key 26 is briefly inserted and withdrawn or through which key 26 is slid or otherwise moved, wherein data is read, written or otherwise transferred between wireless device 22, 24 and key 26 while key 26 is within interface 30.

In yet other embodiments, key interface 30 is a device or electronic component configured to facilitate communication between key 26 and the corresponding wireless device 22, 24 without a physical connection being established therebetween. For example, in one embodiment, key interface 30 may be configured to optically sense or detect data written upon, printed upon or otherwise stored on key 26 and optically write data to key 26 without physically contacting key 26. In another embodiment, key interface 30 may be configured to read and write data from or to interact with key 26 using radio frequency waves. For example, in one embodiment, key interface 30 may comprise a radiofrequency read/write device in those embodiments in which key 26 comprises a radio frequency identification (RFID) tag.

In one embodiment, key interface 30 is configured to read or otherwise receive data from key 26 or to write data to key 26 when key 26 is in relative close proximity to interface 30 such as when key 26 is physically connected to interface 30 or when key 26 is in sufficiently close proximity to permit reading or other extraction of data from key 26 or writing of data to key 26. For example, in one embodiment, interface 30 may be configured to read or write information from key 26 when key 26 if located no further than 2 feet and nominally no further than 1 foot away from interface 30. In such embodiments where information is extracted from key 26 without key 26 being physically connected to interface 30 and when key 26 is within 2 feet and nominally 1 foot from interface 30, inadvertent reading, writing or extraction of information to and from other keys or other structures may be reduced. At the same time, the cost and complexity of interface 30 may be reduced since interface 30 does not have to read or write information from or to a key located greater than 2 feet from interface 30.

Wireless transceiver 32 comprises a device configured to send and receive information wirelessly. In one embodiment, transceiver 32 may be configured to communicate with one or more other devices in a wireless fashion optically such as via infrared communication signals. In yet another embodiment, transceiver 32 may be configured to communicate with one or more other devices in a wireless fashion using radio frequency waves or signals. In one embodiment, transceiver 32 may comprise a presently available wideband or ultra-wideband radio transceiver, facilitating the transmission of information between wireless devices 22 and 24 as schematically indicated by arrows 36.

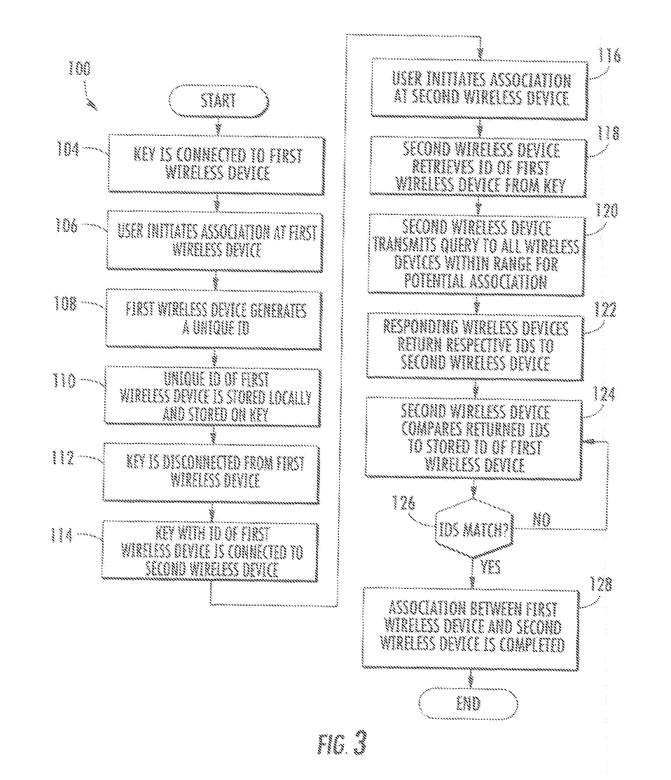

Association module 34 comprises a device configured to generate a random identifier (primary identifier), to store the generated random identifier on key 26, to receive a random identifier from a key 26 and to generates signals for transmission by transceiver 32 that search for one or more other wireless devices having these same random identifier. For purposes of this disclosure, the term “identifier” shall encompass all alphanumeric symbols. FIG. 2 is a functional block diagram illustrating wireless device 22, and in particular association module 34, in more detail. As shown by FIG. 2, association module 34 includes random identifier generator 40, storage device 42, identifier analyzer 44, user controls 46 and controller 48.

Random identifier generator 40 comprises that portion of module 34 configured to generate a random sequence of integers or other values. In one embodiment, random identifier generator 40 may comprise a presently known or future developed software routine for generating a random sequence of integers. Random identifier generator 40 generates, in real time, a unique but temporary identifier for the associated wireless device. For example, in one embodiment, random identifier generator 40 generates a binary value of a predetermined number of bits. The identifier may include any number of bits as deemed suitable for a given application. For example, in one embodiment, random identifier generator 40 may generate a unique identifier having a 56 or 128 bit binary value. In other embodiments, other random identifiers may be generated.

Storage device 42 comprises that portion of module 34 configured to store the random identifier generated by random identifier generator 40. In one embodiment, storage device 42 may additionally store computer readable instructions for controller 48. Storage device 42 may comprise a presently known or future developed volatile or non-volatile storage device, such as a register device or a memory device. For example, storage device 40 may comprise a random access memory (RAM) device. Because storage device 42 provides local storage of the generated random identifier, storage device 42 has a minimum storage capacity equal to or greater than the identifier of bits that form the unique identifier.

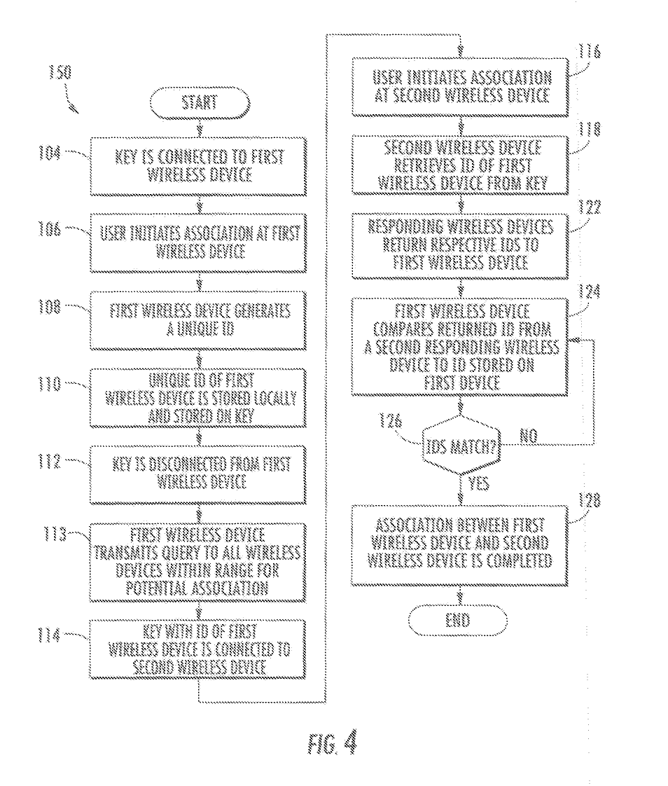

Identifier analyzer 44 comprises that portion of module 34 configured to perform an analysis of identifiers received by transceiver 32 from other wireless devices. In particular, analyzer 44 comprises a device or electronic circuitry configured to compare any returned or received identifier via transceiver 32 with the identifier stored in storage device 42 or stored in key 26. In other embodiments, analyzer 44 is configured to decrypt a received response or answer using the identifier stored in storage device 42 and to compare the decrypted response with the encrypted query transmitted by transceiver 32. When analyzer 44 identifies a match, an association is established as will be described in more detail with respect to FIG. 3.

User controls 46 comprise one or more user interfaces for initiating various operations related to the association or disassociation of wireless devices. For example, input from a user via user controls 46 may command controller 48 to generate control signals to begin an association by generating a random identifier or to complete an association by searching or querying other electronic devices in range which may have a matching identifier. Input from a user via user controls 46 may further direct controller 48 to disassociate other wireless devices from one another. Because association module 34 generates and stores such a random identifier, a user does not need to manually enter an identifier. Consequently, user controls 46 may be minimal in complexity or scope. For example, user controls 46 may merely comprise pushbuttons such as (1) a “load” pushbutton directing the generation of a random identifier, (2) an “associate” push button directing module 34 to search via transceiver 32 for other identifiers and to compare such received identifiers to identify a match and (3) a “disassociate” pushbutton for ending an association and potentially clearing the identifier stored in source device 42. Because such association may be performed with minimal user controls, electronic device 22 may omit more complex and costly user interface components such as a keypad, keyboard or visual display. However, in some embodiments, wireless device 22 may include such components which may have other uses for wireless device 22.

In other embodiments, user controls 46 may be omitted. For example, in other embodiments, module 34 may automatically, in response to initial communication with key 26, attempt to read any stored identifier on key 26. If key 26 does not include a random identifier, module 34 may automatically generate a random identifier, store the generated random identifier on its storage device 42 and also store the random identifier on key 26. Alternatively, if module 34 reads a random identifier on key 26, module 34 may automatically search, using transceiver 32, for other wireless devices having a matching identifier, wherein the association may be completed. In particular embodiments, module 34 may automatically disassociate the particular wireless device 22 with any other wireless devices automatically upon disconnection of key 26 from key interface 30 or after a predetermined period of time following the disconnection of key 26 from wireless device 22.

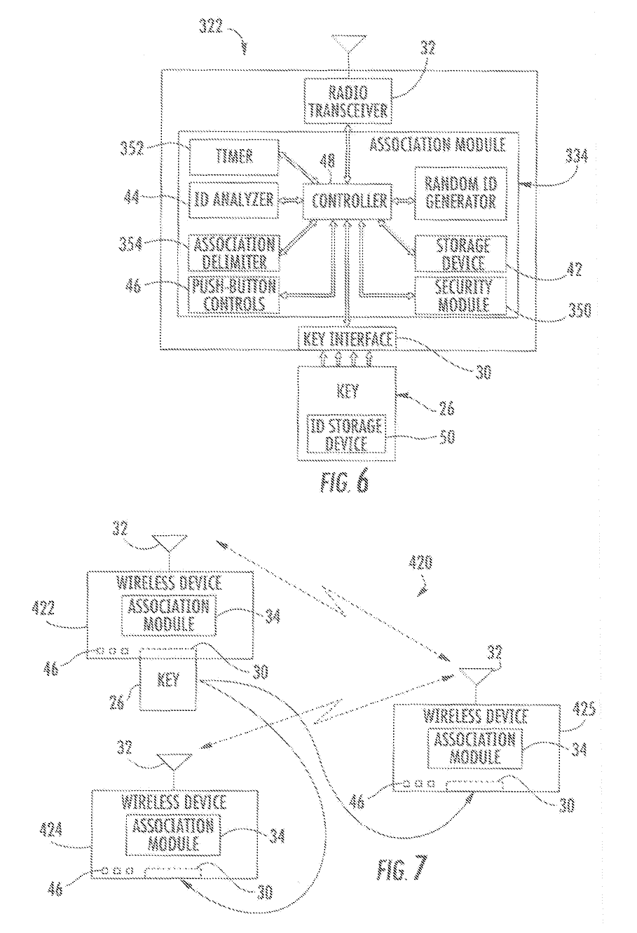

Controller 48 comprises one or more processing units configured to generate control signals directing other components of module 34. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, such processing units may be embodied as part of one or more application-specific integrated circuits (ASICs). Unless otherwise specifically noted, the functional blocks of module 34 or module 334 (described hereafter in FIG. 6) are not limited to any specific combination of hardware circuitry and software, nor to any particular source for the instructions executed by a single processing unit incorporating each of the blocks or by multiple processing units incorporating one or more of the functional blocks.

In the example illustrated, controller 48 generates control signals directing random identifier generator 40 to generate a random identifier and to store the generated random identifier in storage device 42. Controller 48 further generates control signals directing analyzer 44 to receive and compare identifiers received via transceiver 32 with identifiers stored on storage device 42 or key 26 to complete an association. In one embodiment, controller 48 may generate control signals directing analyzer 44 to decrypt a received response and to compare the received response with the originally transmitted query. Controller 40 may also generate control signals causing transceiver 32 to transmit wireless signals to other wireless devices requesting a response including the identifiers associated with the other wireless devices. In another embodiment, controller 40 may generate control signals causing transceiver 32 to transmit a query which is encrypted using the random identifier. As noted above, controller 48 may generate such control signals in response to input received via user controls 46 or automatically in response to communication or connection with key 26 or disconnection with key 26.

According to one example embodiment, association module 34 of wireless device 24 is identical to association module 34 of wireless device 22 as described above. As a result, both wireless devices 22 and 24 are interchangeable as far as the order in which steps are performed to associate one of devices 22, 24 with the other of devices 22, 24. For example, either device 22 or device 24 may generate and write a random identifier to a key 26 and either device 22 or device 24 may alternatively read or otherwise extract a random identifier from a key 26 and transmit signals via a transceiver 32 searching for devices having a matching identifier. In other embodiments, association modules 34 of wireless devices 22 and 24 may be different. For example, in one embodiment, association module 34 of one of devices 22 and 24 may alternatively omit analyzer 44. In another embodiment, association module 34 of one of devices 22 and 24 may alternatively omit random identifier generator 40 and storage device 42.

Key 26 comprises a physical structure or object having an ID storage device 50 (shown in FIG. 2) and configured to store or carry a random identifier. In one embodiment, storage device 50 comprises a non-volatile storage device, such as a registered device or memory device. One example of such a memory device is an EPROM device. Storage device 50 has a storage capacity greater than or equal to the number of bits that form the identifier stored on storage device 42.

According to one example embodiment, key 26 is configured to relatively small and portable. In one embodiment, key 26 is pocket-sized such that key 26 may be carried within a pocket of an article of clothing, such as a coat pocket, a jeans or pants pocket or a shirt pocket. For example, in one embodiment, key 26 has a length less than or equal to about 2 inches, a width less than or equal to about 0.5 inches and a thickness less than or equal to about 0.25 inches. In one embodiment, key 26 may be configured to fit within a palm of a person's hand. In other embodiments, key 26 may have other dimensions.

Key 26 is further configured to facilitate the reading or extraction of the random identifier from key 26 by key interface 30 of one of wireless device 22, 24. In one embodiment, key 26 is configured to be physically connected to key interface 30. In yet other embodiments, key 26 is configured to communicate with key interface 30 while out of physical contact with key interface 30. According to one embodiment, key interface may comprise a device selected from a group of devices consisting of a smart card, a USB memory stick or a writable-readable radiofrequency identification tag. In other embodiments, key 26 may comprise other physical structures or objects configured to store or carry a generated random identifier.

FIG. 3 illustrates one example method 100 for associating wireless devices 22 and 24 of FIGS. 1 and 2. As indicated by step 104, key 26 is inserted into key interface 30 of wireless device 22 to establish a mechanical and electrical connection of key 26 to wireless device 22. As noted above, in particular embodiments, physical connection of key 26 to key interface 30 may be omitted in favor of other communication links such as infrared or radiofrequency signals.

As indicated by step 106, a user initiates association at wireless device 22. For example, in one embodiment, a user may press a “load” pushbutton user control 46 to initiate generation and storage of an identifier on storage device 42 of device 22. As indicated by step 108, random identifier generator 40 generates, in real time, a random identifier for wireless device 22 which is stored locally in storage device 42 a device 22 and is also stored in storage device 50 of key 26 as indicated by step 110. In one embodiment, a network address of device 22 is also stored on key 26. As noted above, step 106 may be omitted in those embodiments in which device 22 automatically generates a random identifier and stores the random identifier in storage device 42 and in storage device 50 upon connection to a key 26 which does not already contain a random identifier.

As indicated by steps 112 and 114, respectively, key 26 is disconnected from wireless device 22 and is connected to key interface 30 of wireless device 24. In one embodiment, connection of key 26 to key interface 30 of device 24 results in a mechanical and electrical connection (a physical connection) of key 26 to wireless device 24. In other embodiments, a connection between key 26 and wireless device 24 may be established without such a physical connection such as with infrared or radio frequency waves.

As indicated by step 116, upon connection of key 26 with key interface 30, a user initiates association at the second wireless device, device 24 (shown in FIG. 1). In one embodiment, the initiation of association may be achieved by the user pressing in “associate” pushbutton user control. In another embodiment, actuation of other user controls 46 a result in the initiation of an association. In still other embodiments, step 116 may be omitted where wireless device 24 automatically detects the connection of interface 30 and key 26 to initiate the association operation at wireless device 24.

As indicated by step 118, controller 48 generates control signals directing key interface 30 to retrieve the identifier stored on storage device 50 of key 26 (shown in FIG. 2). In particular embodiments, controller 48 may further generate control signals directing key interface 32 to retrieve the network address of device 22. Depending upon the type of connection between key 26 and key interface 30, such retrieval may be achieved through an electrical or optical wire or cable connection or may be achieved in a wireless fashion through infrared or radio signals.

As indicated by step 120, controller 48 further generates control signals causing transceiver 34 to emit wireless signals requesting any or all wireless devices receiving such signals to respond with their identifiers, if any. In those embodiments in which a network address of the first device (device 22) is additionally retrieved from key 26 (shown in FIG. 2), the second wireless device (device 24) may alternatively transmit the request or query directly to the network address of the first device. In one embodiment, such signals a comprise radio frequency signals such as from a wideband or ultra-wide emitter. In other embodiments, such signals may comprise optical signal such as infrared signals.

As indicated by step 122, activated wireless devices receiving such signals respond by emitting and transmitting answers in the form of signals which are received by transceiver 32 of wireless device 24 (shown in FIG. 1). Such answers include the identifier of the responding wireless devices. The received identifiers are transmitted from transceiver 32 to analyzer 44 (shown in FIG. 2).

As indicated by step 124, upon receipt of responses from other wireless devices, controller 48 generates control signals directing analyzer 44 to compare any returned identifiers from other wireless devices to be stored identifier at wireless device 24. In one embodiment, analyzer 44 compares the received identifiers with the identifier stored in storage device 42 of device 24. In another embodiment, analyzer 44 compares the received identifiers with the identifier stored in storage device 50 of key 26 which is connected to wireless device 24.

As indicated by steps 126 and 128, if analyzer 44 identifies a match between the identifier stored at wireless device 24 (in storage device 42 or in storage device 50) and the identifier received from another particular wireless device, such as wireless device 22, this match is communicated to controller 48 which completes the association to establish a communication link between wireless device 24 and the wireless device having the matching identifier, wireless device 22. In particular, controller 48 completes the association by storing a flag in storage device 42 that an association has been completed and that communication between wireless devices 24 and 22 may begin using the same identifier of devices 24 and 22 when communications between devices 22 and 24 are addressed. In one embodiment, this link is maintained as long as key 26 remains installed or is otherwise connected to key interface 30 of wireless device 24. In other embodiments, this link is maintained until a user presses a “disassociation” push-button user control 46 or actuates another form of user control 46 to request disassociation.

Alternatively, if an identifier received by wireless device 24 from another wireless device does not match the identifier stored at wireless device 24 (as determined by analyzer 44, shown in FIG. 2), the process continues with analyzer 44 continuing to compare received identifiers from other wireless devices with the stored identifier. Although method 100 has been described as having key 26 initially connected to device 22, wherein device 22 generates a random identifier and stores a random identifier in its storage device 42 and wherein key 26 is connected to device 24 such a device 24 transmits signals searching for a matching identifier and compares the identifier received from key 26 to the identifiers received in responses from other wireless devices, in other embodiments, this relationship may be reversed.

Although method 100 is described as having the wireless device that generates the random identifier as responding to a query from a second device that receives the random identifier from key 26 (shown in FIG. 1), in other embodiments, this relationship may be reversed. For example, FIG. 4 illustrates method 150, another method by which system 20 may operate. Method 150 is similar to method 100 except that in method 150, the first device that generates the random identifier in step 108 also transmits a query to all wireless devices in range for potential association as indicated in step 113. Upon receiving the random identifier from key 26 (steps 116 and 118), the second device responds to the first device per step 122. In particular scenarios, the query from the first device may be made before or after the second device receives the random identifier. Upon receiving an answer from the second device, the first wireless device compares the returned ID (or answer) to determine if a match exists per step 126. If such a match exists, the association is completed per step 128.

Although steps 120-126 of method 100 or steps 113 and 122-126 of method 150 describe a process wherein the random identifiers are themselves transmitted from one device to another device in response to a query requesting the random identifier, in other embodiments, the random identifiers may not be directly communicated between wireless devices, but are instead used as a basis for encrypting queries and/or answers (acknowledgements) between wireless devices. In such an embodiment, the determination of whether the random identifiers of two wireless devices match is achieved by comparing queries and answers that are encrypted or decrypted using the random identifier. For example, in step 120 or step 113, the wireless device may alternatively transmit a query that is encrypted using the random identifier stored in storage device 42 (shown in FIG. 2) or on key 26. As a result, only those devices having the same random identifier will be able to decrypt the query and provide an appropriate matching response per step 122. In steps 124 and 126, analyzer 44 would compare the received answers with the original query to determine if the random identifiers of the two or more devices match.

In yet another embodiment, responding wireless devices in step 122 may additionally encrypt their answers to the encrypted query using their random identifier. In such a case, analyzer 44 (shown in FIG. 2) in steps 124 and 126 decrypts the received response using the random identifier stored on key 26 or in storage device 42 (shown in FIG. 2) and compares the decrypted response with the original query to determine if the random identifiers of two or more devices match. In this way, neither the query nor the answer are transmitted in an unencrypted from between the wireless devices, such as wireless devices 22 and 24. In other embodiments, analyzer 44 may alternatively compare the encrypted answer with what a response encrypted using the random identifier should be to determine if a match exists.

In those embodiments in which the random identifier is used to encrypt or decrypt queries and/or answers (acknowledgments), the algorithm for such queries and answers may vary. In one embodiment, controller 48 is configured to generate such queries and answers such that the queries and answers are unique and not reused, such that the answers or acknowledgments can be generated from the query using a known algorithm and such that the answer or acknowledgment is not exactly the same as the query. For example, in one embodiment, a query might be to randomly generated numbers while the acknowledgment might be the product of those two numbers. In other embodiments, other algorithms may be employed.

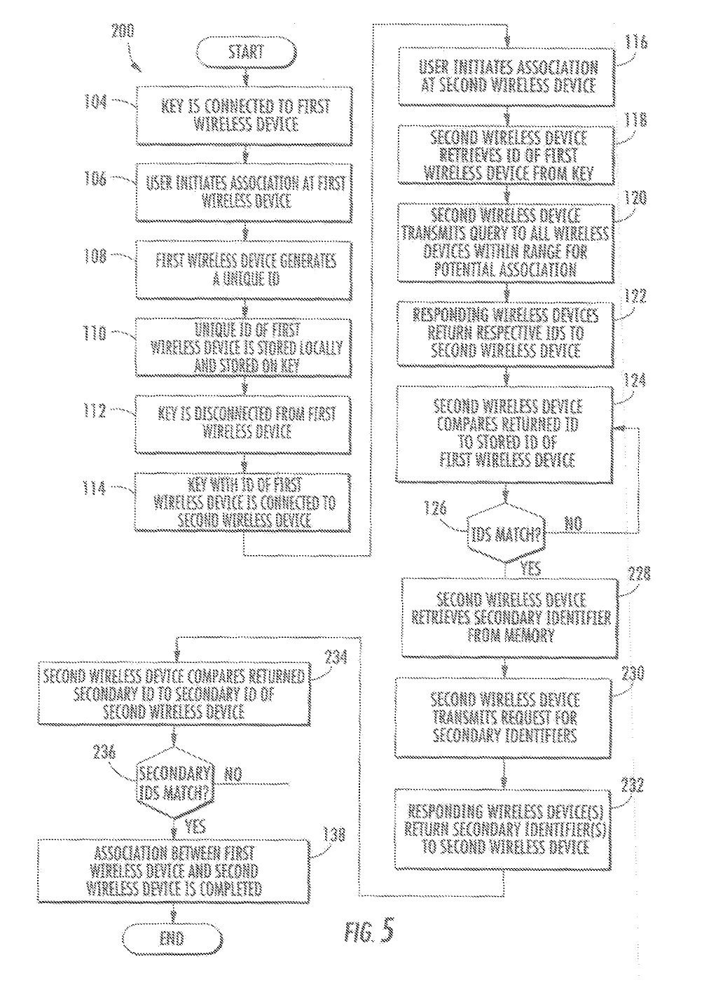

FIG. 5 is a flow diagram illustrating a method 200, another embodiment of method 100 shown and described with respect to FIG. 3. Like method 100, method 200 may be carried out by system 20 (shown and described with respect to FIGS. 1 and 2). Overall, method 200 is similar to method 100 except that method 200 performs a secondary identification match before completing an association between two wireless devices as indicated by step 138. Method 200 is similar to method 100 that the method 200 additionally includes steps 228, 230, 232, 234 and 236. Those remaining steps of method 200 which correspond to steps of method 100 are substantially similar.

As indicated by step 228, once a match of identifiers has been found to complete a primary association, controller 48 (shown in FIG. 2) generates control signals retrieving from storage device 42 a secondary identifier. In one embodiment, the secondary identifier may be a manufacture-specific identifier. For example, all wireless devices of a particular manufacturer or a particular set of products from a particular manufacturer may have stored therein a manufacture-specific identifier.

As indicated by step 230, upon retrieval of the secondary identifier from memory stored device 42, controller 48 generates control signals causing transceiver 32 to emit wireless signals requesting the wireless device with which the primary association was completed to transmit its secondary identifier. As indicated by steps 232 and 234, upon receiving signals indicating the secondary identifier of the other wireless device, controller 48 generates control signals directing analyzer 44 to additionally compare the returned secondary identification to the secondary identification of wireless device 24 that is stored in storage device 42. As indicated by steps 236 and 138, if the secondary identifiers match, the association between the second wireless device, device 24, and the first wireless device, device 22, is completed and a communication link is established therebetween. As indicated by steps 236 and 124, if the secondary identifiers do not match, controller 48 generates control signals causing transceiver 32 to continue transmitting signals requesting other wireless devices to respond with their primary random identifiers.

Although method 200 is illustrated as having wireless device 24 attempting to match the secondary identifier after a match of primary identifiers has been achieved, in other embodiments, wireless device 24 may attempt to match the secondary identifiers before or concurrently with the attempt to match primary identifiers. In such embodiments, wireless device 24 would transmit the request for secondary identifiers to all wireless devices within range of wireless device 24. By additionally matching a secondary identifier such as a manufacture identifier, method 200 prevents or reduces the likelihood of a wireless device of one manufacture from communicating with a wireless device of a different manufacturer. In other embodiments, steps 228-236 may be omitted.

Although method 200 is described as determining whether secondary identifiers stored in two wireless devices match in step 236 before such an association between two wireless devices is completed in step 138, in other embodiments, the secondary identifier may alternatively be stored on key 26 itself. In other words, for an association to be completed, key 26 must have a secondary identifier that matches the secondary identifier on an interfaced wireless device or that is otherwise deemed proper by the wireless device. In such an embodiment, a wireless device, such as wireless device 22 or wireless device 24, is configured to inhibit or prevent the loading or unloading of the primary random identifier onto key 26 without a proper secondary identifier being present on key 26. In another embodiment, key 26 is configured to inhibit or prevent the loading or unloading of a random identifier onto key 26 unless an interfaced wireless device has the proper secondary identifier.

FIG. 6 is a functional block diagram schematically illustrating wireless device 122, another embodiment of wireless device 22 (shown in FIG. 2). Wireless device 122 is similar to wireless device 22 except that wireless device 122 includes association module 134 in lieu of association module 34. Association module 334 provides additional security features. Association module 334 is similar to association module 34 except that association module 134 additionally includes security module 350, timer 352 and association delimiter 354. Those remaining functional blocks or components of module 334 which correspond to functional blocks or components of module 34 are numbered similarly.

Security module 350 comprises of that portion of module 334 configured to provide a secure exchange of data between wireless devices. In particular, security module 350 is configured such that the random identifier of wireless device 24 is not transmitted over a wireless link. In those embodiments in which a secondary identifier is used, security module 350 is further configured such that the secondary identifier is not transmitted over a wireless link. As a result, eavesdroppers are prevented from intercepting the random identifier or the secondary identifier. In one embodiment, security module 360 comprises presently known or future developed secure key exchange software. One example of such software is Diffie-Hellman authenticated key exchange software distributed by MenDist of the Netherlands. In other embodiments, other secure key exchange software or firmware may be employed.

Timer 352 comprises that portion of module 334 configured to track or count the lapse of time. In one embodiment, timer 352 may be provided as part of controller 48. Timer 352 is used to support a security feature in which the random identifier stored on key 26 or stored in storage device 42 expires after a period of non-use. For example, if an association is not completed within a limited predetermined period of time, such as within one minute after extracting the random identifier from key 26, the random identifier is cleared from key 26 and/or storage device 42 by controller 48. In other embodiments, timer 352 may be omitted or may not be used for clearing of random identifiers.

Association delimiter 354 comprises that portion of module 334 configured to support a scenario of multiple substantially simultaneous associations. For example, delimiter 354 may be conveyed to set a limit on the maximum number of simultaneous associations that a given wireless device is allowed. The value of this limit may be either programmable or fixed. In other embodiments, delimiter 354 may be omitted.

FIG. 7 is a functional block diagram schematically illustrating wireless device association system 420, another embodiment of wireless device association system 20 (shown and described with respect to FIGS. 1 and 2). System 420 is similar to system 20 except that system 420 is configured to associate more than two wireless devices. System 420 includes wireless devices 422, 424 and 425. System 420 additionally includes key 26 (shown and described with respect to FIGS. 1 and 2).

Wireless devices 424, 424 and 425 are each substantially identical to one another. In one embodiment, each of wireless devices 422, 424 and 425 are substantially similar to wireless device 22 (shown in FIG. 2). In another embodiment, each of wireless devices 422, 424 and 425 is substantially identical to wireless device 322 (shown in FIG. 6). In other embodiments, wireless devices 422, 424, 425 may be different from one another. For example, in one embodiment, one or more of wireless devices 422, 424, 425 may be specifically configured to generate the random identifier and to store the random identifier without having the capability to extract a random identifier from key 26, to transmit requests for random identifiers from other wireless devices or the ability to compare received random identifiers. At the same time, one or more other wireless devices 422, 424, 425 may be configured to extract a random identifier from key 26, to transmit requests for random identifiers from other wireless devices and to compare received random identifiers with the random identifier extracted from key 26 without having the ability to generate a random identifier or to write or otherwise store the random identifier to key 26.

System 420 may operate according to wither method 100 or method 200 except that system 420 associates more than two wireless devices. According to one mode, key 26 is connected to wireless device 422 via interface 30. Association module 34 (or 334) generates a random identifier which is stored locally in storage device 42 (shown in FIGS. 2 and 5) and which is also stored in storage device 50 of key 26 (shown in FIG. 2). Thereafter, key 26 is disconnected from interface 30 of device 422 and is connected to device 424. Device 424 extracts the random identifier from key 26 and transmits signals requesting wireless device 422 to respond with its stored random identifier. Upon association module 34 (or 334) identifying a match, the association between wireless device 422 and 424 is completed. This association is maintained even upon withdrawal or disconnection of key 26 from interface 30 of device 424. Prior to disconnection of key 26 from interface 30 of device four and 24, the random identifier is stored at wireless device 424. Thereafter, key 26 is withdrawn or disconnected from device 424 and is connected to interface 30 of device 425. Device 425 extracts the random identifier from key 26 and transmits signals requesting wireless devices 422 and 424 to respond with their stored random identifier. Upon association module 34 (4334) identifying a match, the association between wireless device 425 and each of wireless devices 422 and 424 is completed.

According to another mode, wireless devices 424 and 425 extract the random identifier from key 26 but wait until an association command is received via user controls 46 before transmitting signals requesting that other wireless devices within range respond with their random identifiers. In such an embodiment, wireless devices 422, 424 and 425 may concurrently perform or complete their associations. Although FIG. 7 illustrates three such wireless devices being associated, in other embodiments, a greater number of wireless devices may be associated with one another using the same method.

What is claimed is:

1. A method comprising:
storing a first random identifier on a first wireless device;
storing the first random identifier on a physical key; and
moving the first random identifier on the physical key to a second wireless device to associate the second wireless device to the first wireless device.

2. The method of claim 1, wherein the first wireless device generates the first random identifier.

3. The method of claim 1 further comprising disassociating the second wireless device from the first wireless device by disconnecting the key from the second wireless device.

4. The method of claim 1 further comprising searching by the second wireless device for all wireless devices in range having the first random identifier.

5. The method of claim 1 further comprising expiring the first random identifier from the first wireless device upon lapse of a predetermined amount of time if an association is not completed.

6. The method of claim 1 further comprising physically connecting the key to the second wireless device prior to moving the first random identifier.

7. The method of claim 3 further comprising disassociating the second device from the first device by physically disconnecting the key from the second wireless device.

8. The method of claim 1, wherein the first random identifier is stored all in a radio frequency identification (RFID) tag on the key and wherein moving comprises reading the RFID tag.

9. The method of claim 1, wherein the key comprises a device selected from a group of devices consisting of: a smart card, a USB memory stick, or a writable/readable radio frequency identification tag.

10. The method of claim 1 further comprising determining whether the first wireless device and the second wireless device have matching secondary identifiers.

11. The method of claim 1 further comprising:
storing a second random identifier on a third wireless device;
storing the second random identifier on the physical key;
moving of the second random identifier on the physical key to the second wireless device to associate the second wireless device to the third wireless device.

12. The method of claim 1, wherein the first wireless device is a wireless video source and wherein the second wireless device is a wireless video presentation device.

13. The method of claim 12, wherein the first wireless device is selected from a group of wireless video sources consisting of a video cassette player, a video disc player, a set-top cable box, a set-top satellite box, and an integrated circuit video player and wherein the second wireless device is selected from a group of wireless presentation devices consisting of: a wireless video display or a wireless video projector.

14. The method of claim 1, wherein the first wireless device and the second wireless device omit any built in association.

15. The method of claim 1, wherein the association is completed without use of a keypad, keyboard, display or cables.

16. The method of claim 1, wherein the first random identifier is cleared from the physical key after a predetermined period of elapsed time after the first random identifier is stored on the physical key.

17. An apparatus comprising:
a first wireless device comprising:
a transceiver;
a random identifier generator;
a storage device;
a physical key interface; and
a controller configured to generate control signals, wherein the generator generates a random identifier, the controller stores the generated random identifier in the storage device, the key interface stores the generated random identifier to an interfaced physical key and the transceiver responds to signals searching for one or more electronic devices having the random identifier in response to the control signals.

18. An apparatus comprising:
a first wireless device comprising:
a transceiver;
a key interface configured to receive a random identifier from a physical key; and
a controller configured to generate control signals, wherein the transceiver transmits signals searching for one or more second wireless devices having the random identifier in response to the control signals.

19. The apparatus of claim 18 further comprising:
a random identifier generator; and
a storage device, wherein the generator generates a random identifier, wherein the controller stores the generated random identifier in the storage device, wherein the key interface stores the generated random identifier to an interfaced key and wherein the transceiver responds to signals searching for one or more second electronic devices having the random identifier in response to the control signals.

20. The apparatus of claim 18, wherein the first wireless device is one of a wireless video source and a wireless video presentation device.
